(19) United States
(12) Patent Application Publication
(10) Pub. No.: US 2026/0073403 A1
(43) Pub. Date: Mar. 12, 2026

(54) SYSTEMS AND METHODS TO DETERMINE HYDROGEN SOURCES IN FUEL TANKS

(71) Applicant: TOYOTA MOTOR ENGINEERING & MANUFACTURING NORTH AMERICA, INC., Plano, TX (US)

(72) Inventors: Michael R. Koch, Milford, MI (US); Arlo C. Eitzer, Ann Arbor, MI (US); Amy H. Ryan, Torrance, CA (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-shi (JP)

(21) Appl. No.: 18/882,403

(22) Filed: Sep. 11, 2024

(51) Int. Cl. G06Q 30/018; G07C 5/00; G08C 17/02

(52) U.S. Cl. CPC G06Q 30/018; G07C 5/008; G08C 17/02

(57) ABSTRACT

Systems and methods to calculate and monitor the amount of green and other hydrogen present and used in a fuel tank.

### TECHNICAL FIELD

The subject matter described herein relates generally to hydrogen fueling and, more particularly, to systems and methods to determine and monitor the amount of hydrogen, in fuel tanks, received from different sources.

### BACKGROUND

In fuel cell applications or vehicles that use hydrogen fuel, the fuel can come from many difference processes that vary in terms of the source. However, consumers of the fuel have no method to determine the source of the hydrogen.

### SUMMARY

The various embodiments described herein provide solutions to calculate and monitor the amount of hydrogen produced from different methods that are present and used in a vehicle fuel tank. For example, “green” hydrogen is produced through electrolysis of water powered by renewable energies such as wind or solar, whereas “gray” hydrogen is created from natural gas or methane using steam methane reformation and without capturing greenhouse gases made during the steam methane reformation process. Other embodiments provide methods to calculate the amount, e.g., of green hydrogen, that has been added to a vehicle fuel tank, and how much has been used by the vehicle over a period of time.

A generalized embodiment provides a computer-implemented method to determine an amount of hydrogen in a fuel tank. A communication link is established with a hydrogen origination point. Hydrogen is transferred from the hydrogen origination point and to the fuel tank. Processing circuitry then determines, over the communication link, the source of the hydrogen based on the process used to produce the hydrogen. Thereafter, processing circuitry determines the amount of hydrogen in the fuel tank that was received from one or more sources.

Another generalized embodiment provides a system to determine an amount of hydrogen in a fuel tank. The system includes a fuel tank having hydrogen therein received from a hydrogen origination point. The system also includes processing circuitry communicably coupled to the fuel tank and hydrogen origination point. The processing circuitry has memory with instructions stored thereon to perform operations including determining a source of the hydrogen based on a process used to produce the hydrogen; and determining an amount of the hydrogen received from the source.

In yet another generalized embodiment, a computer-implemented method to determine an amount of hydrogen in a fuel tank is provided. Here, a communication link is established with a hydrogen origination point. Hydrogen is then received into the fuel tank from the hydrogen origination point. Processing circuitry then determines the source of the hydrogen in the fuel tank.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the system, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a diagrammatic illustration of a hydrogen consumption analysis system in accordance with at least one embodiment of the present disclosure.

FIG. 2 is a diagrammatic illustration of the hydrogen consumption analysis system in accordance with at least one embodiment of the present disclosure.

FIG. 3 is a flow chart of a method to determine an amount of hydrogen in a fuel tank, according to certain illustrative embodiments of the present disclosure.

FIG. 4 is a schematic diagram of a processor circuit, in accordance with at least one embodiment of the present disclosure.

### DETAILED DESCRIPTION

The present disclosure is generally directed to systems and methods to determine the amount of hydrogen produced from different methods that are present and used in a vehicle hydrogen tank. For fuel cell applications or vehicles that use hydrogen fuel, the fuel can come from different processes that vary in terms of source (e.g., fossil fuels, electrolysis) and these sources are colored coded depending on the process (e.g., green, blue, red, gray). The colors roughly correlate to how renewable the hydrogen source is.

Accordingly, embodiments of the present disclosure provide methods and systems to calculate the amount of hydrogen that come from various methods (e.g., green, blue, gray, etc.) during refueling. Thereafter, the system calculates the amount of hydrogen that comes from each source, with a focus on “green” source hydrogen in certain embodiments. The amount of the differently sourced hydrogen fuel will then be used to understand the percentage and amounts of the “color”of hydrogen used during the lifetime of the fuel cell application.

As described herein, color codes are used to identify the source of hydrogen. Hydrogen itself is a colorless gas, but there are around nine color codes to identify hydrogen. The colors codes of hydrogen refer to the source or the process used to make hydrogen. In certain illustrative embodiments, these codes are: green, blue, gray, brown or black, turquoise, purple, pink, red and white. Green hydrogen is produced through a water electrolysis process by employing renewable electricity. The reason it is called green is that there is no CO2 emission during the production process. Water electrolysis is a process which uses electricity to decompose water into hydrogen gas and oxygen.

Blue hydrogen is sourced from fossil fuel. However, the CO2 is captured and stored underground (carbon sequestration). Some attempt to utilize the captured carbon, called carbon capture, storage and utilization (CCSU). Utilization is not essential to qualify for blue hydrogen. As no CO2 is emitted, so the blue hydrogen production process is categorized as carbon neutral.

Gray hydrogen is produced from fossil fuel and commonly uses a steam methane reforming (SMR) method. During this process, CO2 is produced and eventually released to the atmosphere.

Black or brown hydrogen is produced from coal. The black and brown colors refer to the type bituminous (black) and lignite (brown) coal. The gasification of coal is a method used to produce hydrogen. However, CO2 and carbon monoxide are produced as by-products and released to the atmosphere.

Turquoise hydrogen can be extracted by using the thermal splitting of methane via methane pyrolysis. The process, though at the experimental stage, removes the carbon in a solid form instead of CO2 gas.

Purple hydrogen is made though using nuclear power and heat through combined chemo thermal electrolysis splitting of water.

Pink hydrogen is generated through electrolysis of water by using electricity from a nuclear power plant.

Red hydrogen is produced through the high-temperature catalytic splitting of water using nuclear power thermal as an energy source.

White hydrogen refers to naturally occurring hydrogen.

The hydrogen consumption analysis system described herein may be implemented as a process at least partially implemented on a display, and operated by a control process executing on a processor that accepts user inputs from a suitable user-interface and other control devices, and that is in communication with one or more hydrogen consumption modules and remote processors. In that regard, the control process performs certain specific operations in response to different inputs or selections made at different times, and/or in response to real-time or near-real-time user inputs.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. It is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

These descriptions are provided for exemplary purposes, and should not be considered to limit the scope of the vehicle door activation system described herein. Certain features may be added, removed, or modified without departing from the spirit of the claimed subject matter.

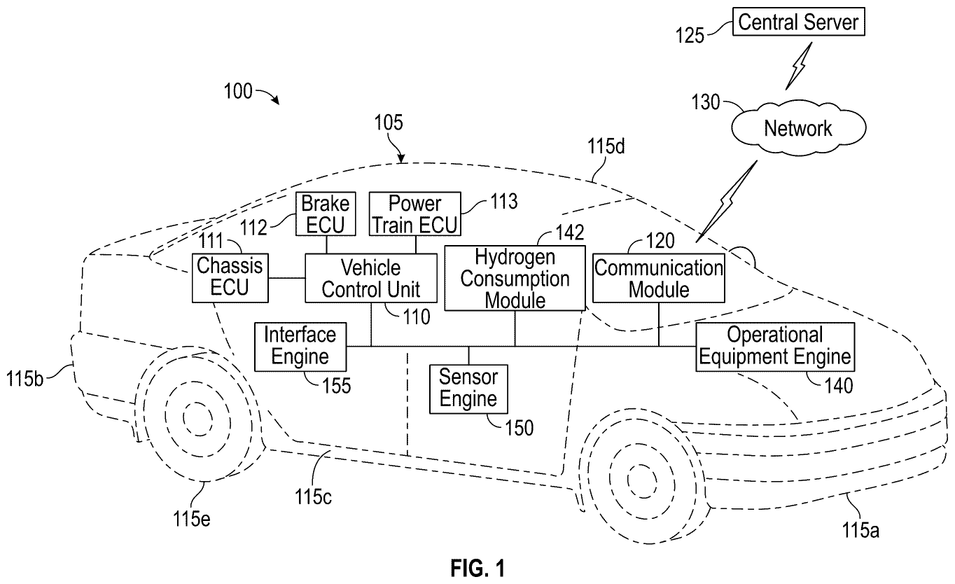

FIG. 1 is a diagrammatic illustration of a hydrogen consumption analysis system in accordance with at least one embodiment of the present disclosure. In an example, a hydrogen consumption analysis system is referred to by the reference numeral 100 and includes a vehicle 105, such as a car, and a vehicle control unit 110 located on the vehicle 105. The vehicle 105 may include a front portion 115a (including a front bumper), a rear portion 115b (including a rear bumper), a right side portion 115c (including a right front quarter panel, a right front door, a right rear door, and a right rear quarter panel), a left side portion 115d (including a left front quarter panel, a left front door, a left rear door, and a left rear quarter panel), and wheels 115e. More specifically, the rear portion 115b includes a truck bed 117 having a tailgate member 118, a first side wall 119a and a second side wall 119b.

A communication module 120 is operably coupled to, and adapted to be in communication with, the vehicle control unit 110. The communication module 120 is adapted to communicate wirelessly with a central server 125 via a network 130 (e.g., a 3G network, a 4G network, a 5G network, a Wi-Fi network, or the like). The central server 125 may provide information and services including but not limited to include location, mapping, route or path, and topography information. Further, communication module 120 may communicate with a hydrogen origination point such as, for example, a fuel pump system at a service station using near-field communication or some other communication technique. However, that same hydrogen origination point may also communicate with hydrogen consumption analysis system 100 over network 130 in certain other embodiments.

An operational equipment engine 140 is operably coupled to, and adapted to be in communication with, the vehicle control unit 110 and hydrogen consumption module 142 which is utilized to perform the methods described herein. A sensor engine 150 is operably coupled to, and adapted to be in communication with, the vehicle control unit 110. The hydrogen consumption module 142 is adapted to monitor the fuel tank (not shown) and various components of, for example, the operational equipment engine 140.

An interface engine 155 is operably coupled to, and adapted to be in communication with, the vehicle control unit 110. In addition to, or instead of, being operably coupled to, and adapted to be in communication with, the vehicle control unit 110, the communication module 120, the operational equipment engine 140, the sensor engine 150, and/or the interface engine 155 may be operably coupled to, and adapted to be in communication with, another of the components via wired or wireless communication (e.g., via an in-vehicle network). In some examples, the vehicle control unit 110 is adapted to communicate with the communication module 120, the operational equipment engine 140, the sensor engine 150, and the interface engine 155 to at least partially control the interaction of data with and between the various components of hydrogen consumption analysis system 100.

The term “engine” is meant herein to refer to an agent, instrument, or combination of either, or both, agents and instruments that may be associated to serve a purpose or accomplish a task—agents and instruments may include sensors, actuators, switches, relays, power plants, system wiring, computers, components of computers, programmable logic devices, microprocessors, software, software routines, software modules, communication equipment, networks, network services, and/or other elements and their equivalents that contribute to the purpose or task to be accomplished by the engine. Accordingly, some of the engines may be software modules or routines, while others of the engines may be hardware and/or equipment elements in communication with any or all of the vehicle control unit 110, the communication module 120, the network 130, or a central server 125.

In this example, the vehicle 105 also includes a chassis electronic control unit (ECU) 111 which controls elements of the vehicle's suspension system, a brake ECU 112 which controls the braking system or elements thereof, a power train ECU 113 (variously known as an engine ECU, power plant ECU, motor ECU, or transmission ECU) that controls elements of the motor and drivetrain, and sensor engine 150.

A reader of ordinary skill in the art will understand that other components or arrangements of components may be found in a vehicle 105, and that the same general principles apply to electric vehicles, internal combustion vehicles, and hybrid vehicles. For example, a power train ECU 113 may control both motor and transmission components. Alternatively, a separate motor ECU and transmission ECU may exist, or some functions of a motor ECU or transmission ECU may be performed by the VCU 110.

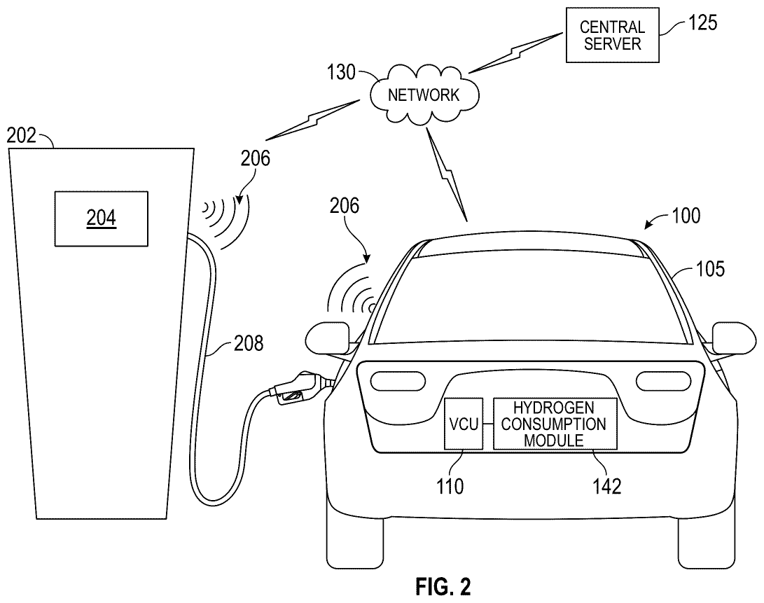

FIG. 2 is a diagrammatic illustration of the hydrogen consumption analysis system in accordance with at least one embodiment of the present disclosure. It is worth noting that the components of the vehicle 105 may be located either permanently or temporarily as a part of the vehicle 105. Although not shown, the vehicle control unit (VCU) 110 includes a processor and a memory, and is operably coupled to hydrogen consumption module 142 and the communication module 120 (also not shown). To perform the functions of various embodiments described herein, the communication module 120 is capable of communicating over network 130 or other suitable communication protocols such as, for example, near-field communication with hydrogen origination point 202. In this example, hydrogen origination point 202 is a fuel pump at a gas station. However, in other embodiments, hydrogen origination point 202 may be any source of hydrogen fuel such as an underground reservoir or some node connected to underground transportation conduits for hydrogen.

Hydrogen origination point 202 includes processing circuitry 204 and other necessary circuitry to perform functions and communicate with vehicle control unit 110 over network 130 or near-field communication link 206. A fuel pump hose 208 also forms part of hydrogen origination point 202 and provides hydrogen to the fuel tank (not shown) of vehicle 105. Further, also not shown, hydrogen consumption module 142 is also communicably coupled to the fuel tank in order to monitor the fuel levels and consumption of hydrogen during operation of vehicle 105.

In the illustrative embodiments described herein, data relating to the source and amount of hydrogen supplied by hydrogen origination point 202 to vehicle 105 is provided. In certain embodiments, this data is provided by central server 125 over network 130 to processing circuitry 204 and/or vehicle control unit 110. In certain embodiments, this data is provided to processing circuitry 204, which in turn communicates the data to vehicle control unit 110 over near-field communication link 206. In alternative embodiments, central server 125 is in communication with both processing circuitry 204 and vehicle control unit 110 in order to receive data related to the amount of hydrogen provided to vehicle 105 and communicate the sourcing data of that fuel to one or both of hydrogen origination point 202 or vehicle 105.

In certain illustrative embodiments of the present disclosure, during the filing process, vehicle control unit 110, in conjunction with hydrogen consumption module 142, calculates the amount of hydrogen input into the fuel tank during filling. In doing so, vehicle control unit 110 calculates the amount of hydrogen being provided through hose 208 which is sourced from “green” sources, “gray” sources, “blue” sources, etc. using sourcing data received from processing circuitry 204 or central server 125. Using any suitable mathematical model, vehicle control unit 110 updates the calculation for any hydrogen fuel already in the fuel tank to account for previous fill-ups-thereby also calculating the amount of hydrogen (and its source(s)) used by vehicle 105 over a desired time period.

This source and consumption data would then be saved by vehicle control unit 110 and, thereafter, used for filling control and/or energy supervisory control for data collection. Filling control is the process by where the fuel station control can work with the vehicle (communication fill) or without (non-communication fill) in order to fill the hydrogen tanks at a high rate without compromising the integrity of the hydrogen tanks. Supervisory c refers to a central processor which is in control of many of the major functions of a vehicle and also has highest authority for directing other electronic control units. In this case, energy supervisory control is one sub-function within the supervisory controller which would be tasked with recording and tracking the hydrogen filling and energy source percentages throughout the vehicle life cycle. Such data can be stored locally by vehicle control unit 110 or uploaded to some remote storage over communication links 206 or 130. Further, the consumption and source data can also be displayed inside vehicle 105 using one of its displays (or other means of communication such as, for example, audible communication to passengers).

Accordingly, vehicle control unit 110 provides the ability to understand hydrogen fuel consumption of a fuel cell application. Using sourcing data received over communication links 130 or 206, vehicle control unit 110 determines the content of the hydrogen being used for fill (e.g., whether the hydrogen is green, blue, etc.) and then calculates the percentage of such hydrogen (e.g., green, blue, etc.) in the tank and used over the lifetime of the fuel cell application (e.g., vehicle 105). This information can then be used for various purposes including, for example, fleet management or tracking of energy use for public or private purposes.

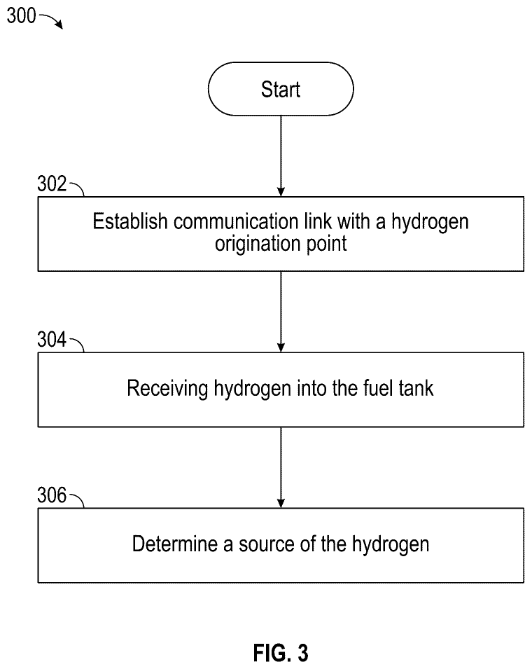

FIG. 3 is a flow chart of a method to determine an amount of hydrogen in a fuel tank, according to certain illustrative embodiments of the present disclosure. At block 302 of method 300, processing circuitry (e.g., vehicle control unit 110) is used to establish a communication ink with a hydrogen origination point, such as fuel pump 202. In one illustrative method, vehicle control unit 110 establishes the communication link 206 with processor 204 of fuel pump 202. While in other embodiments, the communication link may be established over network 130 which in turn provides communication with processor 204.

At block 304, hydrogen is received into the fuel tank. In this example, the hydrogen originated from the fuel pump 202. In other examples, the hydrogen may have originated from some other source such as, for example, an underground pipe, a truck or reservoir. Nevertheless, hydrogen is communicated through hose 208 and into the vehicle fuel tank.

At block 306, the source of the hydrogen communicated to the fuel tank is determined. In this example, vehicle control unit 110 communicates with processor 204 of fuel pump 202 in order to obtain data related to the source of the hydrogen (e.g., a color-coded source). For example, the hydrogen may be from a green source, blue source, etc. Alternatively, a percentage of the hydrogen may be from a green source, and another percentage from a blue source, etc. Regardless of the source, the corresponding data is communicated to vehicle control unit 110 for further processing, as described herein. In this example, the source data is uploaded to processor 204 and/or server 125 each time the hydrogen origination point is refilled.

As previously discussed, data related to the source of the hydrogen may be used for various purposes. In one example, the data may be displayed to a driver or passenger inside the vehicle. In other examples, the data may be communicated to a remote server or processor for use in fleet management or some other application.

In the case of displaying the data inside a vehicle, a display unit (not shown) is part of vehicle 105. In some examples, the display unit may include one, or any combination, of a central display unit associated with a dash of the vehicle 105, an instrument cluster display unit associated with an instrument cluster of the vehicle 105, and/or a heads-up display unit associated with the dash and a windshield of the vehicle 105.

In some examples, a portable user device belonging to an occupant of the vehicle 105 may be coupled to, and adapted to be in communication with, the display via an interface engine. For example, the portable user device may be coupled to, and adapted to be in communication with, the interface engine via the an I/O device (e.g., the USB port and/or the Bluetooth communication interface). In an example, the portable user device is a handheld or otherwise portable device which is carried by a user who is a driver or a passenger on the vehicle 105. In addition, or instead, the portable user device may be removably connectable to the vehicle 105, such as by temporarily attaching the portable user device to the dash, a center console, a seatback, or another surface in the vehicle 105. In another example, the portable user device may be permanently installed in the vehicle 105. In some examples, the portable user device is, includes, or is part of one or more computing devices such as personal computers, personal digital assistants, key fobs, cellular devices, mobile telephones, wireless devices, handheld devices, laptops, audio devices, tablet computers, game consoles, cameras, and/or any other suitable devices. In several examples, the portable user device is a smartphone such as, for example, an iPhone® by Apple Incorporated.

A reader of ordinary skill in the art will understand that other components or arrangements of components may be found in a vehicle 105, and that may of the same general principles apply to electric vehicles, internal combustion vehicles, and hybrid vehicles.

It is noted that flow diagrams are provided herein for exemplary purposes; a person of ordinary skill in the art will recognize myriad variations that nonetheless fall within the scope of the present disclosure. For example, the logic of flow diagrams may be shown as sequential. However, similar logic could be parallel, massively parallel, object oriented, real-time, event-driven, cellular automaton, or otherwise, while accomplishing the same or similar functions. In order to perform the methods described herein, a processor may divide each of the steps described herein into a plurality of machine instructions, and may execute these instructions at the rate of several hundred, several thousand, several million, or several billion per second, in a single processor or across a plurality of processors. Such rapid execution may be necessary in order to execute the method in real time or near-real time as described herein.

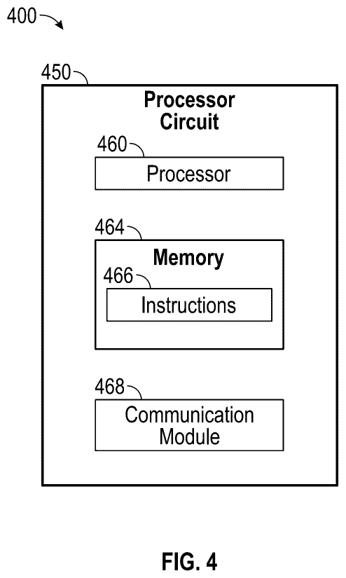

FIG. 4 is a schematic diagram of a processor circuit 450, in accordance with at least one embodiment of the present disclosure. The processor circuit 450 may be implemented in the system 100 or processor 204, or other devices or workstations (e.g., third-party workstations, network routers, etc.), or on a cloud processor or other remote processing unit, as necessary to implement the methods described herein. As shown, the processor circuit 450 may include a processor 460, a memory 464 having instructions 466 thereon, and a communication module 468. These elements may be in direct or indirect communication with each other, for example via one or more buses.

The processor 460 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 460 may also comprise another hardware device, a firmware device, or any combination thereof configured to perform the operations described herein. The processor 460 may also be implemented as a combination of computing devices, e.g., a combination of a DSP and a microprocessor, a plurality of microprocessors, one or more microprocessors in conjunction with a DSP core, or any other such configuration.

The memory 464 may include a cache memory (e.g., a cache memory of the processor 660), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 464 includes a non-transitory computer-readable medium. The memory 464 may store instructions 466. The instructions 466 may include instructions that, when executed by the processor 460, cause the processor 460 to perform the operations described herein. Instructions 466 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 468 can include any electronic circuitry and/or logic circuitry to facilitate direct or indirect communication of data between the processor circuit 450, and other processors or devices. In that regard, the communication module 468 can be an input/output (I/O) device. In some instances, the communication module 468 facilitates direct or indirect communication between various elements of the processor circuit 450 and/or the system 100. The communication module 468 may communicate within the processor circuit 450 through numerous methods or protocols. Serial communication protocols may include but are not limited to United States Serial Protocol Interface (US SPI), Inter-Integrated Circuit (I²C), Recommended Standard 232 (RS-232), RS-485, Controller Area Network (CAN), Ethernet, Aeronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to software updates, firmware updates, preset sharing between the processor and central server, or readings from vehicle or environmental sensors) may be accomplished using any suitable wireless or wired communication technology, such as a cable interface such as a universal serial bus (USB), micro USB, Lightning, or Fire Wire interface, Bluetooth, Wi-Fi, ZigBee, Li-Fi, or cellular data connections such as 2G/GSM (global system for mobiles), 3G/UMTS (universal mobile telecommunications system), 4G, long term evolution (LTE), WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

The technology described herein may be implemented on manually controlled vehicles or driver-assist vehicles. The technology may be implemented in diverse combinations of hardware, software, and firmware, depending on the implementation or as necessitated by the structures and modules already present in existing vehicles. The system may be employed on vehicles with automatic transmission, manual transmissions, or vehicles with simulated shifting, including continuously variable transmission (CVT), infinitely variable transmission (IVT), hybrid transmissions (e.g., a hybrid vehicle with 4-speed automatic transmission simulating 10 gears), and fully electric vehicles.

Accordingly, the logical operations making up the embodiments of the technology described herein may be referred to variously as operations, steps, blocks, objects, elements, components, or modules. Furthermore, it should be understood that these may occur or be arranged in any order, unless explicitly claimed otherwise or a specific order is necessitated by the claim language or by the nature of the component or step.

These and other advantages will be readily apparent to those ordinarily skilled in the art having the benefit of this disclosure.

Methods and embodiments described herein further relate to any one or more of the following paragraphs:
1. A computer-implemented method to determine an amount of hydrogen in a fuel tank, the method comprising establishing a communication link with a hydrogen origination point; receiving hydrogen into a fuel tank, the hydrogen being received from the hydrogen origination point; determining, via the communication link, a source of the hydrogen based on a process used to produce the hydrogen; and determining an amount of the hydrogen received from the source.
2. The computer-implemented method of paragraph 1, wherein the hydrogen origination point is a gas station fuel pump.
3. The computer-implemented method of paragraphs 1 or 2, wherein a color code is used to identify the source of the hydrogen.
4. The computer-implemented method of any of paragraphs 1-3, wherein the source is at least one of a water electrolysis production process; a fossil fuel production process; a coal production process; a methane pyrolysis process; a nuclear power process; or a natural process.
5. The computer-implemented method of any of paragraphs 1-4, wherein the fuel tank is a vehicle fuel tank.
6. The computer-implemented method of any of paragraphs 1-5, wherein determining the amount of hydrogen comprises calculating an amount of the hydrogen received by the fuel tank, from the source, over a period of time.
7. The computer-implemented method of any of paragraphs 1-6, further comprising calculating a percentage of hydrogen received from multiple sources over the period of time.
8. A system to determine an amount of hydrogen in a fuel tank, the system comprising a fuel tank having hydrogen therein received from a hydrogen origination point; and processing circuitry communicably coupled to the fuel tank and hydrogen origination point, the processing circuitry comprising memory having instructions stored thereon to perform operations comprising: determining a source of the hydrogen based on a process used to produce the hydrogen; and determining an amount of the hydrogen received from the source.
9. The system of paragraph 8, wherein the hydrogen origination point is a gas station fuel pump.
10. The system of paragraphs 8 or 9, wherein a color code is used to identify the source of the hydrogen.
11. The system of any of paragraphs 8-10, wherein the source is at least one of: a water electrolysis production process; a fossil fuel production process; a coal production process; a methane pyrolysis process; a nuclear power process; or a natural process.
12. The system of any of paragraphs 8-11, wherein the fuel tank is a vehicle fuel tank.
13. The system of any of paragraphs 8-12, wherein determining the amount of hydrogen comprises calculating an amount of the hydrogen received by the fuel tank, from the source, over a period of time.
14. The system of any of paragraphs 8-13, further comprising calculating a percentage of hydrogen received from multiple sources over the period of time.
15. A computer-implemented method to determine an amount of hydrogen in a fuel tank, the method comprising: establishing a communication link with a hydrogen origination point; receiving hydrogen into a fuel tank, the hydrogen being received from the hydrogen origination point; and determining, using processing circuitry, a source of the hydrogen.
16. The computer-implemented method of paragraph 15, wherein the hydrogen origination point is a gas station fuel pump.
17. The computer-implemented method of paragraphs 15 or 16, wherein a color code is used to identify the source of the hydrogen.
18. The computer-implemented method of any of paragraphs 15-17, wherein the source is at least one of a water electrolysis production process; a fossil fuel production process; a coal production process; a methane pyrolysis process; a nuclear power process; or a natural process.
19. The computer-implemented method of any of paragraphs 15-18, wherein the fuel tank is a vehicle fuel tank.
20. The computer-implemented method of any of paragraphs 15-19, further comprising calculating a percentage of the hydrogen received by the fuel tank, from multiple sources, over a period of time.

Moreover, the methods described herein may be embodied within a system comprising processing circuitry to implement any of the methods, or a in a non-transitory computer-readable medium comprising instructions which, when executed by at least one processor, causes the processor to perform any of the methods described herein.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the cargo seat adjustment system. Connection references, e.g., attached, coupled, connected, and joined are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” Unless otherwise noted in the claims, stated values shall be interpreted as illustrative only and shall not be taken to be limiting.

The above specification, examples and data provide a complete description of the structure and use of exemplary embodiments of the vehicle door activating system as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter. Additionally, sensors external to the vehicle may be employed to provide or supplement any of the sensor data described hereinabove. Alternatively, machine learning algorithms or other AI systems may be used to estimate variables from sparse, noisy, or entwined data streams without departing from the spirit of the present disclosure.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

1. A computer-implemented method to determine an amount of hydrogen in a fuel tank, the method comprising:
establishing, via processing circuitry, a communication link with a hydrogen origination point;
receiving hydrogen into a fuel tank, the hydrogen being received from the hydrogen origination point;
obtaining, by the processing circuitry over the communication link, data relating to a source and amount of hydrogen being supplied to the fuel tank, the source of the hydrogen being based on a process used to produce the hydrogen;
determining, by the processing circuitry using the data, the source of the hydrogen; and
determining, by the processing circuitry using the data, the amount of the hydrogen received from the source.

2. The computer-implemented method of claim 1, wherein the hydrogen origination point is a gas station fuel pump.

3. The computer-implemented method of claim 1, wherein a color code is used to identify the source of the hydrogen.

4. The computer-implemented method of claim 1, wherein the source is at least one of:
a water electrolysis production process;
a fossil fuel production process;
a coal production process;
a methane pyrolysis process;
a nuclear power process; or
a natural process.

5. The computer-implemented method of claim 1, wherein the fuel tank is a vehicle fuel tank.

6. The computer-implemented method of claim 1, wherein determining the amount of hydrogen comprises calculating an amount of the hydrogen received by the fuel tank, from the source, over a period of time.

7. The computer-implemented method of claim 1, further comprising calculating a percentage of hydrogen received from a source over a period of time.

8. A system to determine an amount of hydrogen in a fuel tank, the system comprising:
a fuel tank having hydrogen therein received from a hydrogen origination point; and
processing circuitry communicably coupled to the fuel tank and hydrogen origination point, the processing circuitry comprising memory having instructions stored thereon to perform operations comprising:
establishing, using processing circuitry, a communication link with the hydrogen origination point;
receiving hydrogen into the fuel tank, the hydrogen being received from the hydrogen origination point;
obtaining, by the processing circuitry over the communication link, data relating to a source and amount of hydrogen being supplied to the fuel tank, the source of the hydrogen being based on a process used to produce the hydrogen;
determining, by the processing circuitry using the data, the source of the hydrogen; and
determining, by the processing circuitry using the data, the amount of the hydrogen received from the source.

9. The system of claim 8, wherein the hydrogen origination point is a gas station fuel pump.

10. The system of claim 8, wherein a color code is used to identify the source of the hydrogen.

11. The system of claim 8, wherein the source is at least one of:
a water electrolysis production process;
a fossil fuel production process;
a coal production process;
a methane pyrolysis process;
a nuclear power process; or
a natural process.

12. The system of claim 8, wherein the fuel tank is a vehicle fuel tank.

13. The system of claim 8, wherein determining the amount of hydrogen comprises calculating an amount of the hydrogen received by the fuel tank, from the source, over a period of time.

14. The system of claim 8, further comprising calculating a percentage of hydrogen received from a source over a period of time.

15. A computer-implemented method to determine an amount of hydrogen in a fuel tank, the method comprising:
establishing, using processor circuitry, a communication link with a hydrogen origination point;
receiving hydrogen into a fuel tank, the hydrogen being received from the hydrogen origination point;
obtaining, by the processing circuitry over the communication link, data relating to a source and amount of the hydrogen being supplied to the fuel tank, the source of the hydrogen being based on a process used to produce the hydrogen; and
determining, using the processing circuitry, a source of the hydrogen.

16. The computer-implemented method of claim 15, wherein the hydrogen origination point is a gas station fuel pump.

17. The computer-implemented method of claim 15, wherein a color code is used to identify the source of the hydrogen.

18. The computer-implemented method of claim 15, wherein the source is at least one of:
a water electrolysis production process;
a fossil fuel production process;
a coal production process;
a methane pyrolysis process;
a nuclear power process; or
a natural process.

19. The computer-implemented method of claim 15, wherein the fuel tank is a vehicle fuel tank.

20. The computer-implemented method of claim 15, further comprising calculating a percentage of the hydrogen received by the fuel tank, from a source, over a period of time.
